(19) United States
(12) Patent Application Publication
(10) Pub. No.: US 2011/0204531 A1
(43) Pub. Date: Aug. 25, 2011

(54) Method of Manufacturing Wafer Lens

(76) Inventors: Akiko Hara, Oshitani (JP); Masashi Saito, Sato (JP); Toshiyuki Imai, Fujii (JP)

(21) Appl. No.: 13/119,755

(22) PCT Filed: Apr. 24, 2009
(86) PCT No.: PCT/JP2009/058156

§ 371 Date: Mar. 18, 2011

(30) Foreign Application Priority Data
Sep. 22, 2008 (JP) 2008-242402
Sep. 22, 2008 (JP) 2008-242407

(51) Int. Cl. B29D 11/00; B29C 71/02; B29C 71/04

(52) U.S. Cl. 264/1.36

(57) ABSTRACT

Provided is a method of manufacturing a wafer lens in which the surface configuration of the lens section can be transferred with high precision. The method possesses a step of preparing a molding die having plural molding surfaces corresponding to an optical surface configuration of the optical member; a filling step of filling the photo-curable resin in between the surface of the substrate and the molding surface of the molding die; a photo-curing step of exposing the photo-curable resin to light to accelerate curing; a heating step of conducting a heat treatment for the photo-curable resin having been cured in the photo-curing step; and a releasing step of releasing the molding die from the photo-curable resin after conducting the heating step, and further comprises a step of conducting a post-cure treatment for the optical member.

### TECHNICAL FIELD

The present invention relates to a method of manufacturing a wafer lens to prepare a wafer lens in which an optical member made of a photo-curable resin is formed on at least one surface of a substrate.

### BACKGROUND

Conventionally, in the manufacturing field of an optical lens, studied has been a technique by which a lens section (optical member) made of a curable resin such as a thermosetting resin or the like is provided on a glass fiat plate to obtain an optical lens exhibiting high heat resistance (refer to Patent Document 1, for example).

Further, a method of manufacturing an optical lens, which is applied to this technique, forms a so-called “wafer lens” in which an aperture composed of a metal film to adjust an amount of incoming light is formed on the surface of a glass flat plate, and a plural optical members made of a curable resin are further provided on the surface of the aperture. Then, in a state of incorporated plural lenses, spacers are sandwiched, and a protrusion portion having been simultaneously molded together with the optical surface is laminated to form plural pairs of lenses via adhesion, and developed has been a process of cutting the glass flat plate section after formation thereof. Reduction in manufacturing cost of the optical lens can be made via this manufacturing method.

Incidentally, in an method of manufacturing a double-surface lens array in which optical members are provided on the front and back of both surfaces of a glass substrate for a wafer lens, releasing is first conducted after filling a curable resin in onto one surface of the glass substrate for complete curing. Further, there is a method by which a curable resin is filled in on another surface of a glass substrate, and completely cured for releasing. Further, as another method, known is a method by which releasing from each of both surfaces is conducted one by one after a curable resin is filled in onto each of both surfaces, and simultaneously exposed to UV radiation for complete curing (refer to Patent Document 2, for example).

### PRIOR ART DOCUMENT

### Patent Document

Patent Document 1: Japanese Patent No. 3926380

Patent Document 2: Japanese Patent Open to Public Inspection Publication No. 2006-106229

### DISCLOSURE OF THE INVENTION

### Problems to be Solved by the Invention

However, when releasing is conducted after filling a curable resin in onto each of surfaces of the foregoing glass substrate for complete curing there appears a problem such that accuracy drops via generation of warpage of the glass substrate. Further, when releasing is conducted after conducted after filling a curable resin in onto both surfaces of the glass substrate at the same time for complete curing, since the curable resins on both surfaces are cured all at once, there appears another problem such that a curing duration becomes longer, and a light exposure apparatus becomes complicated because of exposure to light from both surfaces.

The present invention has been made on the basis of the above-described situation, and it is an object of the present invention to provide a method of manufacturing a wafer lens through which generation of warpage can be suppressed, and reduction of light exposure time and simplification of an apparatus can be made.

### Means to Solve the Problems

The object of the present invention is accomplished by the following structures.

(Structure 1) A method of manufacturing a wafer lens in which an optical member made of a photo-curable resin is formed on one surface of a substrate, comprising a filling step of preparing a molding die having plural molding surfaces corresponding to an optical surface configuration of the optical member to fill the photo-curable resin in between the one surface of the substrate and the molding surface of the molding die; a photo-curing step of exposing the photo-curable resin to light to accelerate photo-curing; a heating step of conducting a heat treatment for the photo-curable resin having been cured in the photo-curing step; and a releasing step of releasing the molding die from the photo-curable resin after conducting the heating step.

(Structure 2) The method of Structure 1, comprising the step of conducting a post-cure treatment for the optical member having been formed on the one surface of the substrate after conducting the releasing step.

(Structure 3) A method of manufacturing a wafer lens in which a first optical member made of a photo-curable resin is formed on one surface of a substrate, and a second optical member made of a photo-curable resin is formed on another surface of the substrate, comprising a preparation step of preparing a first molding die having plural molding surfaces corresponding to an optical surface configuration of the first optical member; another preparation step of preparing a second molding die having plural molding surfaces corresponding to an optical surface configuration of the second optical member; a first filling step of filling the photo-curable resin in between the one surface of the substrate arid the molding surface of the first molding die; a second filling step of filling the photo-curable resin in between the another surface of the substrate and the molding surface of the second molding die; a first curing step of exposing the photo-curable resin having been filled in via the first filling step to accelerate curing; a second curing step of exposing the photo-curable resin having been filled in via the second filling step to accelerate curing, a first heating step of conducting a heat treatment after conducting the first curing step; a second heating step of conducting a heat treatment after conducting the second curing step; a first releasing step of releasing the first molding die from the photo-curable resin after conducting the first heating step; and a second releasing step of releasing the second molding die from the photo-curable resin after conducting the second heating step.

(Structure 4) The method of Structure 3, comprising the step of conducting a post-cure treatment for an optical member having been formed on the substrate, after conducting at least one of the first releasing step and the second releasing step.

(Structure 5) The method of Structure 3, comprising the step of conducting a post-cure treatment for both optical members having been formed on both surfaces of the substrate after conducting the first releasing step and the second releasing step.

(Structure 6) The method of any one of Structures 2, 4 and 5, comprising the step of conducting the heat treatment at a temperature lower than the post-cure treatment temperature.

(Structure 7) The method of Structure 2, comprising the step of simultaneously conducting formation of an antireflective film and the post-cure treatment in an antireflective film formation step, wherein the antireflective film is formed on the optical member after conducting the releasing step.

(Structure 8) The method of structure 5, comprising the step of simultaneously conducting formation of an antireflective film and the post-cure treatment in an antireflective film formation step, wherein the antireflective film is formed on the optical member after conducting the first releasing step or the second releasing step.

### Effect of the Invention

In the present invention, warpage of a substrate, which is easily generated during releasing, can be inhibited. Further, reduction of curing time can be made by conducting a post-cure treatment. Specifically in the first and second molding steps, a light exposure apparatus can be also simplified because of exposure to light from one surface of the substrate.

### BRIEF DESCRIPTION OF THE DRAWINGS

FIG. 1 is an oblique perspective view showing an outline configuration of a wafer lens assembly.

FIGS. 2a-2b are an oblique perspective view showing an outline configuration of a master and an oblique perspective view showing an outline configuration of a sub-master, respectively.

FIGS. 3a-3e each are a diagram of reaction of an OH group on the master surface with a releasing agent in which an alkoxysilane group is used at the terminus as an example of a functional group capable of hydrolysis.

FIGS. 4a-4c each are a diagram to explain a method of manufacturing a sub-master.

FIGS. 5a-5h each are a diagram to explain a method of manufacturing a wafer lens.

FIGS. 6a-6d each are a diagram to explain a method of manufacturing a wafer lens assembly.

FIGS. 7a-7g each are another diagram to explain a method of manufacturing a wafer lens.

FIGS. 8a-8h each are another diagram to explain a method of manufacturing a wafer lens assembly.

### DESCRIPTION OF THE PREFERRED EMBODIMENTS

Next, the preferred embodiments of the present invention will be described referring to drawings.

### The First Embodiment

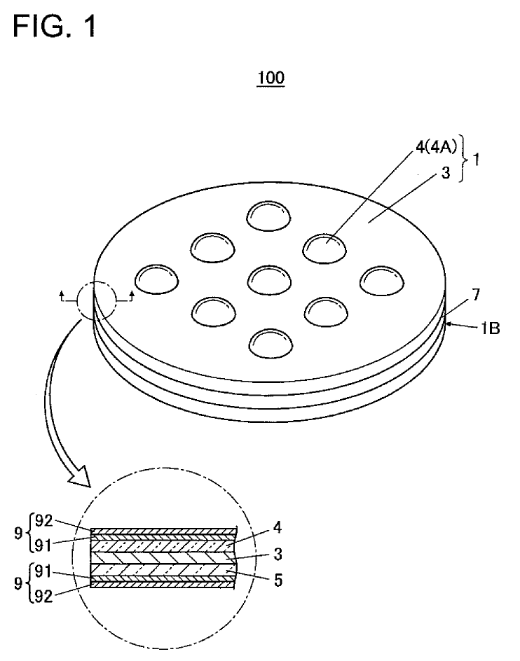

FIG. 1 is an oblique perspective view showing an outline configuration of a wafer lens assembly.

Wafer lens assembly 100 has a structure in which spacer 7 is sandwiched between wafer lens 1 and wafer lens 1B.

### <Wafer Lens>

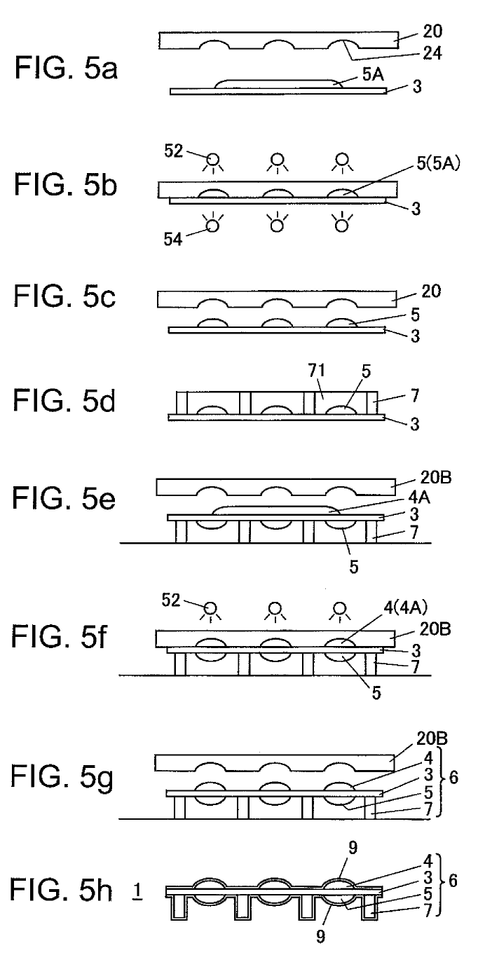

Wafer lens 1 comprises disk-shaped glass substrate 3 and plural lens sections 4 and 5 (refer to FIGS. 5a-5h), and has a structure in which the plural lens sections 5 are placed in an array form on both the front and back surfaces of glass substrate 3. In lens sections 4 and 5, microscopic structures such as diffractive grooves and level differences may be formed on the surface of an optical plane.

Lens sections 4 and 5 are formed of resins 4A and 5A (refer to FIGS. 5a-5h). A curable resin material may be used as resins 4A and 5A. The curable resin material is classified roughly into a photo-curable resin and a thermosetting resin, but photo-curable resins are used as resins 4A and 5A.

Usable examples of the photo-curable resins include an acrylic resin, an allyl ester resin and so forth, and these resins can be cured via radical polymerization reaction. If the photo-curable resin is an epoxy type resin, it can be hardened by cationic polymerization. As other photo-curable resins, epoxy based resins, for example, are usable, and the resins can be cured via cationic polymerization reaction.

Next, the above-described resins will be explained in detail.

### (Acrylic Resin)

(Meth)acrylate used for polymerization reaction is not specifically limited, and the following (meth)acrylate prepared by a conventional manufacturing method can be used. Examples thereof include ester(meth)acrylate, urethane(meth)acrylate, epoxy(meth)acrylate, ether(meth)acrylate, alkyl(meth)acrylate, alkylene(meth)acrylate, (meth)acrylate having an aromatic ring, and (meth)acrylate having an alicyclic structure. These can be used singly or in combination with at least two kinds.

Specifically, (meth)acrylate having an alicyclic structure may be desirable, and the alicyclic structure may contain an oxygen atom or a nitrogen atom. Examples thereof include cyclohexyl(meth)acrylate, cydopentyl(meth)acrylate, cyclobeptyl(meth)acrylate, bicycloheptyl(meth)acrylate, tricyclo decyl(meth)acrylate, tricyclodecan dimethanol(meta)acrylate, isobornyl(meta)acrylate, hydrogenerated dibisphenol(meta)acrylate, and so forth. Further, those having an adamantane moiety are preferable. Examples thereof include 2-alkyl-2-adamantyl(meth)acrylate (refer to Japanese Patent O.P.I. Publication. No. 2002-193883), adamantyldi(meta)acrylate (refer to Japanese Patent O.P.I. Publication No. 57-500785), adamantyldicarboxylic acid diallyl (refer to Japanese Patent O.P.I. Publication No. 60-100537), perfluoroadamantyl acrylic acid ester (refer to Japanese Patent O.P.I. Publication No. 2004-123687), 2-methyl-2-adamantyl methacrylate reduced by Shin-Nakamura Chemical Co., Ltd., 1,3-adamantane diol diacrylate, 1,3,5-adamantan triol triacrylate, unsaturated carboxylic acid adamantyl ester (refer to Japanese Patent Publication O.P.I. No. 2000-119220), 3,3′-dialkoxycarbonyl-1,1′biadamantane (refer to Japanese Patent Publication O.P.I. No. 2001-253835), 1,1′-biadamantane compound (refer to U.S. Pat. No. 3,342,880), tetra adamantane (refer to Japanese Patent O.P.I. Publication No. 2006-169177), 2-alkyl-2-hydroxy adamantane, 2-alkylene adamantane, a curable resin with an adamantane moiety possessing no aromatic ring such as 1,3-adamantane di-tert-butyl dicarboxylate and so forth (refer to Japanese Patent O.P.I. Publication No. 2001-322950), bis(hydroxyphenyl)adamantanes, and bis(glycidyl oxyphenyl)adamantane (refer to the Japanese Patent O.P.I. Publication No. 11-35522 and Japanese Patent O.P.I. Publication No. 10-130371).

Further, other reactive monomers are possible to be contained. Examples of (meth)acrylate include methyl acrylate, methyl methacrylate, n-butyl acrylate, n-butyl methacrylate, 2-ethyl hexyl acrylate, 2-ethyl hexyl methacrylate, isobutyl acrylate, isobutyl methacrylate, tert-butyl acrylate, tert-butyl methacrylate, phenyl acrylate, phenyl methacrylate, benzyl acrylate, benzyl methacrylate, cyclohexyl acrylate, cyclohexyl methacrylate, and so forth.

Examples of polyfunctional (meth)acrylate include trimethylolpropan tri(meth)acrylate, pentaerythritol tetra(meth)acrylate, pentaerythritol tri(meth)acrylate, dipenta erythritol hexa(meth)acrylate, dipenta erythritol penta(meth)acrylate, dipenta erythritol tetra(meth)acrylate, dipentaerythritol tri(meta)acrylate, tripenta erythritol octa(meth)acrylate, tripentaerythritol hepta(meta)acrylate, ripenta erythritol hexa(meth)acrylate, tripenta erythritol penta(meth)acrylate, tripenta erythritol tetra(meth)acrylate, tripentaerythritol tri(meta)acrylate, and so forth.

### (Allyl Ester Resin)

Resins each having an allyl group, which is to be cured via radical polymerization are listed below, for example, but the present invention is not limited to those described below.

Examples thereof include bromine-containing (meth)allyl ester containing no aromatic ring (refer to Japanese Patent O.P.I. Publication No. 2003-66201), allyl(meth)acrylate (refer to Japanese Patent O.P.I. Publication No. 5-286896), an allyl ester resin (refer to Japanese Patent O.P.I. Publication No. 5-286896 and Japanese Patent O.P.I. Publication No. 2003-66201), a copolymerizing compound of acrylic acid ester and an epoxy group-containing unsaturated compound (refer to Japanese Patent O.P.I. Publication No. 2003-128725), an acrylate compound (refer to Japanese Patent O.P.I. Publication No. 2003-147072), an acrylic ester compound (refer to Japanese Patent O.P.I. Publication No. 2005-2064), and so forth.

### (Epoxy Resin)

Epoxy resins are not specifically limited as long as they have an epoxy group, and are cured via polymerization with light or heat, and curing initiator, an acid anhydride, a cation generating agent, and so forth are usable. Since a curing shrinkage ratio of an epoxy resin is low, an epoxy resin is preferred in view of possible preparation of a lens with high molding precision.

As types of epoxy, listed are a novolak phenol type epoxy resin, a biphenyl type epoxy resin, and dicyclopentadiene type epoxy resin. Examples thereof include bisphenol F diglycidyl ether, bisphenol A diglycidyl ether, 2,2′-bis(4-glycidyl oxycyclohexyl)propane, 3,4-epoxy-cyclohexyl methyl-3,4-epoxycyclohexan carboxylate, vinylcyclohexene dioxide, 2-(3,4-epoxy cyclohexyl)-5,5-spiro(3,4-epoxy cyclohexane)-1,3-dioxane, bis(3,4-epoxy cyclohexyl)adipate, 1,2-cyclopropanedicarboxylate bisglycidyl ester, and so forth.

A hardener is utilized to constitute a curable resin material, and there is no specific limitation to it. Further, in the present invention, in cases where transmittances of optical materials after adding additives are compared to each other, a hardener is specified to be not included in the additives. As a hardener, an acid anhydride hardener, a phenol hardening agent or the like is preferably usable. Specific examples of the acid anhydride hardener include phthalic anhydride, maleic anhydride, trimellitic anhydride, pyromellitic anhydride, hexahydro phthalic anhydride, 3-methyl-hexahydro phthalic anhydride, 4-methyl-hexahydro phthalic anhydride, a mixture of 3-methyl-hexahydro phthalic anhydride and 4-methyl-hexahydro phthalic anhydride, tetrahydro phthalic anhydride, nadic anhydride, methyl nadic anhydride, and so forth. Further, a curing accelerator may be contained, if desired. There is no specific limitation as long as the curing accelerator exhibits a good curing property, no generation of coloring, and no degradation in transparency of a thermosetting resin, but usable examples thereof include imidazoles such as 2-ethyl-4-methylimidazole (2E4MZ) and so forth, bicyclic amidines and their derivatives such as tertiary amine, quaternary ammonium salt and diazabicycloundecen, phosphine, a phosphonium salt, and so forth. These are used singly or as a mixture of at least two kinds.

Antireflective film 9 (refer to the enlarged portion in FIG. 1) is formed on each of the surfaces of lens sections 4 and 5. Antireflective film 9 has a structure of two layers. First layer 91 is formed on each of lens sections 4 and 5, and second layer 92 is formed thereon.

First layer 91 is a layer made of a high refractive index material having a refractive index of 1.7 or more, and is preferably composed of any of Ta₂O₅, a mixture of Ta₂O₅ and TiO₂, ZrO₂, and a mixture of ZrO₂ and TiO₂. First layer 91 may be composed of TiO₂, Nb₂O₃, or HfO₂. Second layer 92 is a layer composed of a low refractive index material having a refractive index of less than 1.7, and is preferably composed of SiO₂.

In antireflective film 9, first layer 91 and second layer 92 each are formed via a method such as vapor evaporation. Specifically, first layer 91 and second layer 92 are formed while the film forming temperature is kept in the range between −40° C. and +40° C. (preferably between −20° C. and +20° C.) with respect to the melting temperature of conductive paste such as solder applied to a reflow treatment.

In addition, first layer 91 and second layer 92 may further be laminated alternately on first layer 91 and second layer 92 to obtain antireflective film 6 having a structure of 2-7 layers. In this case, a layer brought into direct contact with each of lens sections 4 and 5 may be either a high refractive index material layer or a low refractive index material layer, depending on the kind of lens sections 4 and 5. In the present embodiment, the layer brought into direct contact with lens sections 4 and 5 is a layer composed of a high refractive index material.

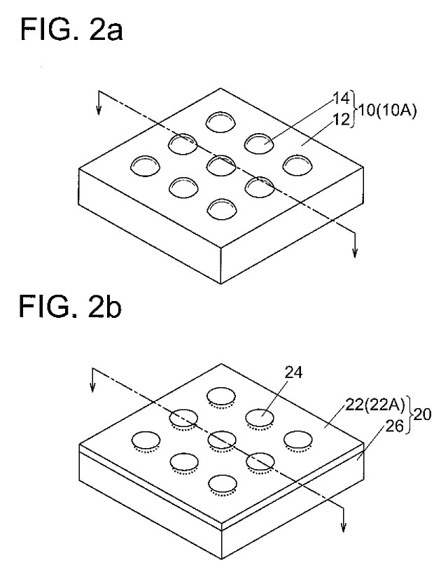

In preparation of wafer lens 1, master mold die 10 (hereinafter, referred to simply as “master 10”) and sub-master mold die 20 (hereinafter, referred to simply as “sub-master 20”) in FIGS. 2a-2b are used.

Master 10 is a mother type used when sub-master 20 is prepared, and sub-master 20 is a mold die used when molding wafer lens 1 (lens section 5). Sub-master 20 is used more than once to mass-produce wafer lens 1, and is different from master 10 in intended use and frequency of use. The present embodiment is used as an example of a precision processing mold die.

### <Master>

As shown in FIG. 2a, in master 10, plural convex portions 14 are formed in the array form on cuboid-shaped base portion 12. The convex portions 14 are portions corresponding to lens sections 5 of wafer lens 1, and are protruded in the form of an approximately hemisphere shape. Incidentally, the outer configuration of master 10 may be such a square in this way, and may also be a round shape. Though the range of a patent right of the present invention is not restricted by this difference, hereafter, a square shape will be described as an example.

The surface (molding surface) configuration of each of convex portions 14 is a positive configuration corresponding to the optical surface configuration (configuration of the surface opposite to glass substrate 3) of each of lens sections 5 to be transferred and molded onto glass substrate 3.

In cases where an optical surface configuration is produced via mechanical processing such as cutting, grinding and so forth, metal or metallic glass is usable as a material for master 10A. As to classification thereof, iron system materials and other alloys can be provided. Examples of the iron system materials include a hot die, a cold die, a plastic die, a high-speed tool steel, a rolled steel in general structural use, a carbon steel in machine structural use, a chrome molybdenum steel, and a stainless steel. Of these, examples of plastic dies include a prehardened steel, a quenched and tempered steel, and an aging-treated steel. Examples of the prehardened steel include a SC type steel, a SCM type steel and a SUS type steel. More specifically, the SC type steel includes PXZ. Examples of the SCM type steel include HPM2, HPM7, PX5, and IMPAX. Examples of the SUS type steel include HPM38, HPM77, S-STAR, G-STAR, STAVAX, RAMAX-S, and PSL. Further, examples of the iron system alloy are disclosed in Japanese Patent O.P.I. Publication No. 2005-113161 and Japanese Patent O.P.I. Publication No. 2005-206913. As non-iron system alloys, well known are a copper alloy, an aluminum alloy and a zinc alloy, and examples of the alloys are disclosed in Japanese Patent O.P.I. Publication No. 10-219373 and Japanese Patent O.P.I. Publication No. 2000-176970. As materials of metallic glass, PdCuSi, PdCuSiNi and so forth may be suitable, because such a material exhibits high machinability in a diamond cutting process, so that a cutting tool has little abrasion. In addition, amorphous alloys such as electroless or electrolytic nickel phosphorus plating may be applicable, because such an alloy also exhibits high machinability in a diamond cutting process. These high machinable materials may be utilized to constitute the entire body of master 10, or may be utilized to cover only the surface of an optical transfer plane by a method such as a plating method, a sputtering method or the like.

Further, glass is also usable as a material of master 10, though the mechanical processing is slightly difficult to be applied. When glass is used for master 10, it is advantageous to obtain light passing through. There is no specific limitation to glass as long as it is conventionally usable glass.

Specifically, as the molding material for master 10, provided are a low melting point glass, and a material capable of easily acquiring flowability at low temperature as metallic glass. When a low melting point glass is used, it is advantageous that light to exposure can be conducted also from the die side of a sample during molding of a UV curable material. The low melting point glass has a glass transition point of about 600° C. or less, and a glass composition of ZnO—PbO—B₂O₃, PbO—SiO₂—B₂O₃, PbO—P₂O₅—SnF₂, or the like. Further, examples of glass capable of melting at 400° C. or less include PbF₂—SnF₂—SnO—P₂O₅ and those having the similar structure. Specific examples thereof include S-FPL51, S-FPL53, S-FSL5, S-BSL7, S-BSM2, S-BSM4, S-BSM9, S-BSM10, S-BSM14, S-BSM15, S-BSM16, S-BSM18, S-BSM22, S-BSM25, S-BSM28, S-BSM71, S-BSM81, S-NSL3, S-NSL5, S-NSL36, S-BAL2 S-BAL3, S-BAL11, S-BAL12, S-BAL14, S-BAL35, S-BAL41, S-BAL42, S-BAM3, S-BAM4, S-BAM12, S-BAH10, S-BAH11, S-BAH27, S-BAH28, S-BAH32, S-PHM52, S-PHM53, S-TIL1, S-TIL2, S-TIL6, S-TIL25, S-TIL26, S-TIL27, S-TIM1, S-TIM2, S-TIM3, S-TIM5, S-TIM8, S-TIM22, S-TIM25, S-TIM27, S-TIM28, S-TIM35, S-TIM39, S-TIH1, S-TIH3, S-TIH4, S-TN6, S-TIH10, S-TIH11, S-TIH13, S-TIH14, S-TIH18, S-TIH23, S-TIH53, S-LAL7, S-LAL8, S-LAL9, S-LAL10, S-LAL12, S-LAL13, S-LAL14, S-LAL18, S-LAL54, S-LAL56, S-LAL58, S-LAL59, S-LAL61, S-LAM2, S-LAM3, S-LAM7, S-LAM51, S-LAM52, S-LAM54, S-LAM55, S-LAM58, S-LAM59, S-LAM60, S-LAM61, S-LAM66, S-LAH51, S-LAH52, S-LAH53, S-LAH55, S-LAH58, S-LAH59, S-LAH60, S-LAH63, S-LAH64, S-LAH65, S-LAH66, S-LAH71, S-LAH79, S-YGH51, S-FTM16, S-NBM51, S-NBH5, S-NBH8, S-NBH51, S-NBH52, S-NBH53, S-NBH55, S-NPH1, S-NPH2, S-NPH53, P-FK01S, P-FKH2S, P-SK5S, P-SK12S, P-LAK13S, P-LASF03S, P-LASFH11S, P-LASFH12S and so forth, but specifically, the present invention is not necessarily limited thereto.

Further, the metallic glass can be similarly shaped easily via molding. Examples of the metallic glass are disclosed in Japanese Patent O.P.I. Publication No. 8-109419, Japanese Patent O.P.I. Publication No. 8-333660, Japanese Patent O.P.I. Publication No. 10-81944, Japanese Patent O.P.I. Publication No. 10-92619, Japanese Patent O.P.I. Publication No. 2001-140047, Japanese Patent O.P.I. Publication No. 2001-303218, and Published Japanese Translation of PCT International Publication No. 2003-534925, but the present invention is not specifically limited thereto.

### <Sub-Master>

Sub-master 20 as an example of a precision processing mold die possesses molding section 22 and substrate 26 as shown in FIG. 2b. On molding section 22, plural concave portions 24 are formed in the army form. The surface (molding surface) configuration of each of concave portions 24 is a negative configuration corresponding to each of lens sections 5 in wafer lens 1, and the surface configuration is dented in an approximately hemisphere configuration in this figure.

Herein, “sub-master 20” is a mold die to mold “lens sections 5”, and “sub-master 20B” shown in FIGS. 5a-5h is a mold die to mold “lens sections 4” to distinguish these for each other. “Sub-master 20B” is basically composed of the same configuration and material as those of “sub-master 20”, and since the surface configuration of each of concave portions 24 only becomes a negative configuration corresponding to each of lens sections 4, only sub-master 20 will be detailed herein.

In the present invention, shown is an example in which sub-master 20 is employed for molding lens sections 5 of wafer lens 1. However, not only sub-master 20 is applied to this, but also sub-master 20 (configuration thereof) is applicable for molding an optical element, a precision element or the like in which fine and precise concavo-convex shape (nanosized concavo-convex shape) is to be formed on the surface. For example, it is also applicable for molding a lens array in which a single lens as well as plural lenses are placed in the array form, for molding a substrate having patterned media or for a technique of molding nanoholes in a nanoimprint technology.

### <<Molding Section>>

Molding section 22 is formed of resin 22A. As resin 22A, a resin exhibiting an excellent releasing property is preferable, and a transparent resin is specifically preferable. The resin is advantageous since it can be released from a die without coating a releasing agent. The resin may be any of a photo-curable resin, a thermosetting resin and a thermoplastic resin.

As the photo-curable resin, listed is a fluorine based resin, and as the thermosetting resin, listed is a fluorine based resin and a silicone based resin. Among them, those exhibiting an excellent releasing property, that is, resins having a low surface energy during curing are preferable. Examples of the thermoplastic resin include transparent olefin based resins exhibiting a comparatively good releasing property such as polycarbonate, a cycloolefin polymer and so forth. In addition, the releasing properties of a fluorine based resin, a silicone based resin and an olefin based resin are good in this order. In this case, substrate 26 may be allowed not to be provided. Use of such a resin becomes further advantageous because of appearance of flexibility thereof during releasing.

Next, the fluorine based resin, the silicone type resin and the thermoplastic resin will be described in detail.

### (Fluorine Based Resin)

Examples of the fluorine type resin include PTFE (polytetrafluoroethylene), PFA (tetrafluoroethylene.perfluoro alkyl vinyl ether copolymer), FEP {tetrafluoroethylene.hexafluoro propylene copolymer (4,6 fluorinated)}, ETFE (tetrafluoroethylene.ethylene copolymer), PVDF (polyvinylidene fluoride (2 fluorinated)), PCTFE (polychlorotrifluoroethylene resin (3 fluorinated)), ECTFE (chlorotrifluoroethylene ethylene copolymer), PVF (polyvinyl fluoride), and so forth.

The fluorine based resin is advantageous in releasing property, heat resistance property, chemical resistance property, insulating property, low friction property and so forth, but is disadvantageous in inferior transparency because of being crystalline. Since the fluorine based resin has a high melting point, a high temperature (about 300° C.) is required during molding.

Further, examples of the molding method include injection molding, extrusion molding, blow molding, transfer molding, and so forth. Among these, FEP, PFA, PVDF and so forth are specifically preferable, because they are excellent in light transmission and also capable of injection molding and extrusion molding.

As a grade capable of melt molding, listed are, for example, Fluon PFA produced by Asahi Glass Co., Ltd., and Dyneon PFA, Dyneon THV and so forth produced by Sumitomo 3M Limited. Especially, in the ease of Dyneon THV series, molding can be performed at comparatively low temperature since it has a low melting point (about 120° C.), and they are preferable since they exhibit high transparency.

Further, as a thermosetting amorphous fluorine resin, CYTOP grade S produced by Asahi Glass Co., Ltd. is also preferable since it exhibits high transmittance and an excellent releasing property.

### (Silicone Based Resin)

As the silicone based resin, there are a one liquid moisture curable type, a two liquid addition reaction type and a two liquid condensation type.

The silicone based resin is advantageous in releasing property, flexibility, heat resistance property, flame retardant property, moisture permeability, low water absorption property, many transparency grades and so forth, but is disadvantageous in large linear expansion coefficient.

Specifically, a silicone resin used for shape-making application, which includes a PDMS (poly dimethyl siloxane) structure is preferable because of excellent releasing property, and RTV elastomer with a high transparency grade is preferable. Preferable examples thereof include TSE3450 (two liquid mixing, addition type) produced by Momentive•Performance Materials Inc., ELASTOSIL M 4647 (two liquid type RTV silicone rubber) produced by WACKER ASAHIKASEI SILICONE CO., LTD., KE-1603 (two liquid mixing, addition type RTV rubber) produced by Shin-Etsu Chemical Co., Ltd., SH-9555 (two liquid mixing, addition type RTV rubber), SYLGARD 184, Silpot 184, WL-5000 series (photosensitive silicone buffer material and capable of patterning via UV) produced by Dow Coming Toray Co., Ltd., and so forth.

In the case of the two liquid type RTV rubber, curing at room temperature or curing by heat is applied for a molding method.

The silicone based resin is advantageous in that it can be released from master 10, and exhibits excellent transferability, and on the other hand, it is disadvantageous in that it does not last only several tens shots to about a hundred shots during molding lens sections 5. In order to make up for this, Ni (nickel) is further coated after transferring onto the silicone based resin. The coating method may be any of electroforming, evaporation and sputtering. The number of shots is increased by this. However, since a releasing property with respect to lens sections 5 is not so good, a releasing agent is further coated on the Ni coat. In such a way, resin 22A for molding section 22 is designed to be PDMS; Ni is coated on the surface; and a releasing agent is further coated to improve a releasing property released from master 10 and lens sections 5, whereby lifetime of sub-master 20 can be extended. Further, it is easy to prepare sub-master 20, leading to cost reduction.

As the releasing agent, employable are materials in which a functional group capable of hydrolysis is bonded to the terminus such as those having a silane coupling agent structure, that is, those having a structure so as to be bonded to OH groups existing on the metal surface via generation of dehydration condensation or hydrogen bonding. In the case of a releasing agent having a silane coupling structure at one terminus and exhibiting releasing function at another terminus, since the more, OH groups are formed on the surface of the sub-master, the more, locations for covalent bonding on the surface of the sub-master increase, stronger bonding can be produced. As a result, no matter how many shots molding is carried out, durability is improved without losing a releasing effect. Further, since a primer layer (a subbing layer, a SiO₂ coat, and so forth) becomes undesired, the effect of improving durability can be obtained while keeping a thin layer.

Examples of the material in which a functional group capable of hydrolysis is bonded to the terminus include materials having an alkoxy silane gaup, a halogenated silane group, a quaternary ammonium salt, a phosphoester group and so forth, preferably as a functional group. Further, the terminal group may be a group so as to generate strong bonding to a metal die, for example, such as triazine thiol. Specific examples thereof include those having an alkoxy silane group represented by the following Formula {the following Formula (B)} or a halogenated silane group represented by the following Formula {the following Formula (C)}.

13 Si(OR1)nR2(3-n) (B)

—SiXmR3(3-m) (C)

In the above formulas, each of R1 and R2 represents an alkyl group (for example, a methyl group, an ethyl group, a propyl group, a butyl group or the like); each of n and m is 1, 2 or 3; R3 represents an alkyl group (for example, a methyl group, an ethyl group, a propyl group, a butyl group or the like), or an alkoxy group (for example, a methoxy group, an ethoxy group, a butoxy group or the like). X represents a halogen atom (for example, Cl, Br or I).

Further, when at least two of R1, R2, R3 and X are bonded to Si, two Rims maybe different, for example, so as to be an alkyl group and an alkoxy group within the range of the above-mentioned groups or atoms.

—SiOH is produced via reaction of alkoxy silane group-SiOR1 and a halogenated silane group-SiX with moisture content. Further, this is bonded to OH groups existing on the surface of a die material made of glass, metal or the like via generation of dehydration condensation or hydrogen bonding.

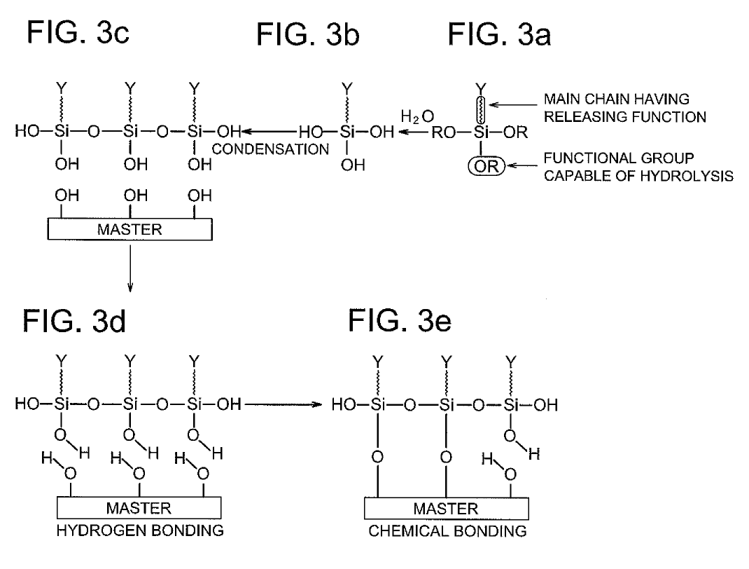

FIGS. 3a-3e each are a diagram of reaction of an OH group on the surface of master 10 with a releasing agent in which an alkoxysilane group is used at the terminus as an example of a functional group capable of hydrolysis.

In FIG. 3a; —OR represents methoxy (—OCH₃) or ethoxy (—OC₂H₅), and methanol (CH₃OH) or ethanol (C₂H₅OH) is generated via hydrolysis, resulting in silanol (—SiOH) shown in FIG. 3b. Then, a condensed product of silanol as shown in FIG. 3c is produced partially via dehydration condensation. Further, as shown in FIG. 3d, adsorption is made by hydrogen bonding with OH groups on the surface of master 10 (inorganic material), and dehydration is finally produced as shown in FIG. 3e to form —O— chemical bonding (covalent bonding). Though FIGS. 3a-3e each show the case of an alkoxy silane group, the case of a halogenated silane group produces basically the same reaction as above.

That is, the releasing agent used in the present invention sis chemically bonded to the surface of a sub-master at one end, and a functional group is oriented at another end to cover the sub-master, whereby a uniformly thin releasing layer exhibiting excellent durability can be formed.

One preferable as a structure on the side exhibiting releasing function is one having low surface energy, for example, a fluorine-substituted hydrocarbon group or a hydrocarbon group.

### (Fluorine-Containing Releasing Agent on the Functional Side)

As the fluorine-substituted hydrocarbon group, specifically preferable is a fluorine-substituted hydrocarbon group having a perfluoro group such as a CF₃(CF₂)ₙ— group, a CF₃CF₃CF(CF₂)_{b}— group or the like (each of a and b is an integer) at one end of a molecular structure. Further, the length of the perfluoro group is preferably two or more in terms of the number of carbons, and the number of CF₂ groups next to CF₃ in the CF₃(CF₂)ₐ— group is preferably at least 5.

Further, the perfluoro group is not necessarily straight-chained, and may have a branch structure. Further, in response to recent environmental problems, preferable is a structure such as CF₃(CF₂)_{c}—(CH₂)_{d}—(CF₂)ₑ— or the like. In this case, c is 3 or less, d is an integer (preferably 1), and e is 4 or less.

The above-described fluorine-containing releasing agent is usually a solid, but in order to coat this agent onto the surface of the sub-master, it should be a solution dissolved in an organic solvent. Though depending on the molecular structure of the releasing agent, many as the solvents are suitably a fluorinated hydrocarbon based solvent or those in which a slight amount of an organic solvent is mixed therein. The concentration of the solvent is not specifically limited, but since it is a feature that a releasing film to be utilized is specifically thin, a low concentration of 1-3% by weight is sufficient.

In order to coat this solution onto the surface of the sub-master, usable are a dip coating method, a spray coating method, a brush coating method and a spin coating method. After coating, a solvent is usually vaporized via natural drying to have a dry coating film. The resulting film thickness is not specifically limited, but a thickness of 20 μm or less is suitable.

Specific examples thereof include OPTOOL DSX, DURASURF HD-1100 and DURASURF HD-2100 produced by Daikin Industries, NOVEC EGC1720 produced by Sumitomo 3M Limited, evaporated triazine-thiol produced by Takeuchi Vacuum Deposition Co., Ltd., amorphous fluorine CYTOP Grade M produced by AGC, and antifouling coat OPC-800 produced by NI Material Co., Ltd., and so forth.

### (Hydrocarbon-Containing Releasing Agent on the Functional Side)

The hydrocarbon group maybe straight-chained like CₙH₂ₙ₊₁, or may be branched. A silicone based releasing agent is included in this classification.

Conventionally, the releasing agent is a composition made of an organopolysiloxane resin as a principal component, and many compositions are known as a composition to form a curing film exhibiting water repellency. For example, Japanese Patent O.P.I. Publication No. 55-48245 proposes a composition composed of a hydroxyl group-containing methyopolysiloxane resin, α,ω-dihydroxydiorganopolysiloxan and organosilane, and is cured to form a film exhibiting excellent releasing and antifouling properties together with water repellency. Further, Japanese Patent O.P.I. Publication No. 59-140280 proposes a composition containing as a principal component a partial cohydrolysis condensation product of organosilane which includes perfluoro alkyl group-containing organosilane and amino group-containing organosilane as a principal component, and forms a curing film exhibiting excellent water repellency and oil repellency.

Specific examples thereof include MOLDSPAT produced by AGC SEIMI CHEMICAL CO., LTD., OLGACHICKS SIC-330 and 434 produced by Matsumoto Fine Chemicals Co., Ltd., SR-2410 produced by Toray Dow Chemical Co., Ltd., and so forth. Further, SAMLAY produced by Nippon Soda Co., Ltd. maybe used as a self-organizing monomolecular film.

### (Thermoplastic Resin)

As the thermoplastic resin, listed are transparent resins such as an alicyclic hydrocarbon based resin, an acrylic resin, a polycarbonate resin, a polyester resin, a polyether resin, a polyamide resin, a polyimide resin and so forth, but of these, an alicyclic hydrocarbon based resin is preferably usable. When a thermoplastic resin is used for sub-master 20, a conventional injection molding technique can be diverted as it is, whereby sub-master 20 can be easily produced. Further, when the thermoplastic resin is an alicyclic hydrocarbon based resin, lifetime of sub-master 20 is extended because of very low moisture absorbency. Further, the alicyclic hydrocarbon based resin such as a cycloolan resin or the like is usable as a die for a long duration, since it exhibits excellent light resistance and optical transparency, and exhibits less deterioration when using a short wavelength such as that of a UV light source or the like for the purpose of curing an actinic ray curable resin.

As the alicyclic hydrocarbon based resin, one represented by the following Formula (1) is exemplified.

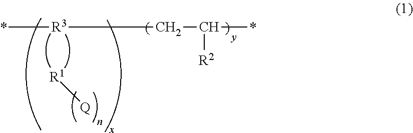

In the above-described Formula (1), each of “x” and “y” represents a copolymerization ratio and is the real number satisfying 0/100≦y/x≦95/5. Symbol “n” is 0, 1 or 2, and represents the substitution number of substituent Q. “R1” is a (2+n) valent group of at least one selected from the group consisting of hydrocarbon groups each having 2-20 carbon atoms. “R2” is a hydrogen atom or is composed of carbon and hydrogen, and is a monovalent group of at least one selected from the group consisting of structures having 1-10 carbon atoms. “R3” is a divalent group of at least one selected from the group consisting of hydrocarbon groups having 2-20 carbon atoms. “Q” is a monovalent group of at least one selected from the group consisting of structures each represented by COOR4 (R4 represents a hydrogen atom or a hydrocarbon, and is a monovalent group of at least one selected from the group consisting of structures each having 1-10 carbon atoms).

In foregoing Formula (1), R1 is preferably a divalent group of at least one selected from the group of hydrocarbon groups each having 2-12 carbon atoms; more preferably a divalent group represented by the following Formula (2) {in Formula (2), p is an integer of 0-2}; and still more preferably a divalent group with p being 0 or 1 in foregoing Formula (2).

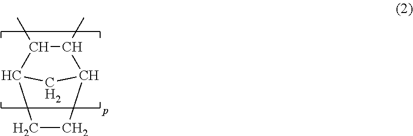

The structure of R1 may be used singly or in combination with at least two kinds. Examples of R2 include a hydrogen atom, a methyl group, an ethyl group, an n-propyl group, an i-propyl group, a n-butyl group, a 2-methylpropyl group and so forth, but R2 is preferably at least one of a hydrogen atom and a methyl group, and most preferably a hydrogen atom. Examples of R3 as a preferable sample of a structural unit including this group include (a), (b) and (c) in the case of n=0 (provided that in the Formulae (a), (b) and (c), R1 is as mentioned above). Further, n is preferably 0.

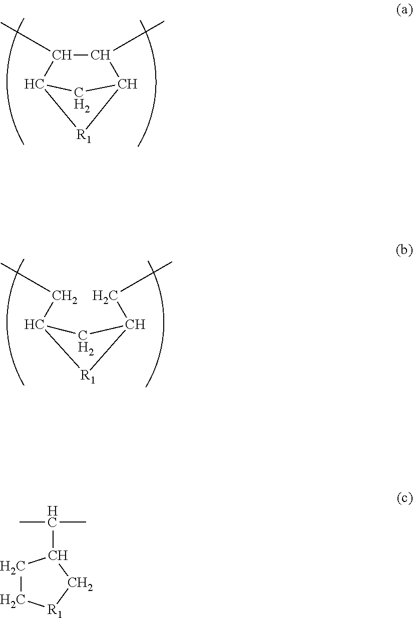

In the present embodiment, the type of copolymerization is not specifically restricted, and applicable examples thereof include commonly known types of copolymerization such as random copolymerization, block copolymerization and alternating copolymerization, but the random copolymerization is preferable.

Further, the polymer employed in the present embodiment may have a repeating structural unit derived from another copolymerizable monomer, if desired, as long as matter properties of a product obtained by a molding method of the present embodiment are not deteriorated. The copolymerization ratio is not specifically limited, but it is preferably 20 mol % or less, and more preferably 10 mol % or less. In the case of the ratio exceeding the foregoing, high precision optical components tend not to be obtained because of degradation of optical properties. The type of copolymerization in this case is not specifically restricted, but random copolymerization is preferable.

As another example of a preferable thermoplastic alicyclic hydrocarbon type polymer applied for sub-master 20, the repeating unit having an alicyclic structure contains repeating unit (a) having an alicyclic structure represented by the following Formula (4) and repeating unit (b) having a chain structure represented by the following Formula (5) and/or the following Formula (6) and/or the following Formula (7) so as to give a total content of at least 90% by weight, and further, a polymer having a repeating unit (b) content of 1-10% by weight is exemplified.

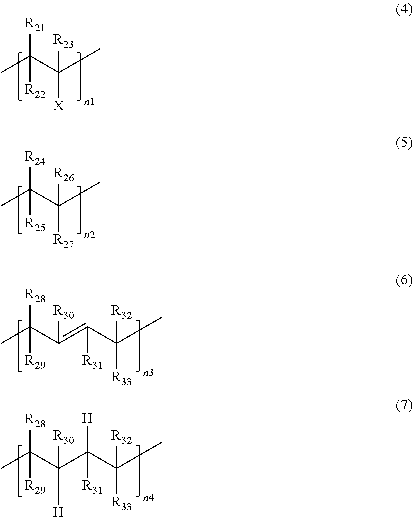

In Formula (4), Formula (5), Formula (6), and Formula (7), each of R₂₁-R₃₃ is independently a hydrogen atom, a chained hydrocarbon group, a halogen atom, an alkoxy group, a hydroxy group, an ether group, an ester group, a cyano group, an amino group, an imido group, a silyl group, or a chained hydrocarbon group or the like substituted with a polar group (a halogen atom, an alkoxy group, a hydroxy group, an ester group, a cyano group, an amide group, an imido group, or a silyl group). Specifically, examples of the halogen atom include a fluorine atom, a chlorine atom, a bromine atom and an iodine atom, and examples of the chained hydrocarbon group substituted by a polar group include a halogenated alkyl group having 1-20 carbon atoms, preferably 1-10 carbon atoms, and more preferably 1-6 carbon atoms. Examples of the chained hydrocarbon group include an alkyl group having 1-20 carbon atoms, preferably 1-10 carbon atoms, and more preferably 1-6 carbon atoms, and also an alkenyl group having 2-20 carbon atoms, preferably 2-10 carbon atoms, and more preferably 2-6 carbon atoms.

X in Formula (4) described above represents an alicyclic hydrocarbon group, and the number of carbon atoms constituting this group is usually 4-20, preferably 4 to 10, and more preferably 5-7. Birefringence can be reduced by making the number of carbon atoms constituting an alicyclic structure to fall within this range. Further, the alicyclic structure is not limited to a single ring structure, and may be a polycyclic structure such as a norbornane ring and so forth.

The alicyclic hydrocarbon group may have a carbon-carbon unsaturated bond, but the content of the carbon-carbon unsaturated bond is 10% or less with respect to the total carbon-carbon bonds, preferably 5% or less, and more preferably 3% or less. Transparency and heat-resistance can be improved by making the carbon-carbon unsaturated bond in the cyclic hydrocarbon group to fall within this range. Further, a hydrogen atom, a hydrocarbon group, a halogen atom, an alkoxy group, a hydroxy group, an ester group, a cyano group, an amide group, an imido group, a silyl group, or a chained hydrocarbon group substituted by a polar group (a halogen atom, an alkoxy group, a hydroxy group, an ester group, a cyano group, an amide group, an imido group, or a silyl group) may be bonded to carbons constituting the cyclic hydrocarbon group. Among them, a hydrogen atom or a chained hydrocarbon group having 1-6 carbon atoms is preferable in view of heat resistance and low water absorption.

Further, though above-described Formula (6) includes a carbon-carbon unsaturated bond in the main chain, and above-described Formula (7) includes a carbon-carbon saturated bond in the main chain, when transparency and heat resistance are largely demanded, the content of unsaturated bonds is usually 10% or less with respect to the total carbon-carbon bonds constituting the main chain, preferably 5% or less, and more preferably 3% or less.

In an alicyclic hydrocarbon based copolymer in the present embodiment, the total content of repeating unit (a) having an alicyclic structure represented by Formula (4) and repeating unit (b) as a chain structure represented by Formula (5) and/or Formula (6) and/or Formula (7) is usually at least 90% in terms of weight standard, preferably at least 95%, and more preferably at least 97%. Low birefringence, heat resistance, low water absorption and mechanical strength are highly balanced by making the total content to fall within the above-described range.

As a method of manufacturing the above-described alicyclic hydrocarbon based copolymer, provided is a method by which an aromatic vinyl based compound and another polymerizable monomer are polymerized, and the main chain and an aromatic carbon-carbon unsaturated bond are hydrogenated.

The molecular weight of the copolymer before hydrogenation is in the range of 1,000 1,000,000 in terms of polystyrene (or polyisoprene) conversion weight average molecular weight (Mw) measured by GPC, preferably in the range of 5,000-500,000, and more preferably in the range of 10,000-300,000. When the weight average molecular weight (Mw) of the copolymer is too small, a molded product of the resulting alicyclic hydrocarbon based copolymer is degraded in strength, and in contrast, when it is too large, hydrogenation reactivity becomes poor.

Specific examples of aromatic vinyl based compounds preferably usable in the above-described method include styrene, α-methylstyrene, α-ethylstyrene, α-propylstyrene, α-isopropylstyrene, α-t-butyl styrene, 2-methylstyrene, 3-methylstyrene, 4-methylstyrene, 2,4-diisopropylstyrene, 2,4-dimethylstyrene, 4-t-butyl styrene, 5-t-butyl-2-methylstyrene, monochlorostyrene, dichlorostyrene, monofluorostyrene, 4-phenylstyrene, and the like. Among them, styrene, 2-methylstyrene, 3-methylstyrene, 4-methylstyrene and so forth. These aromatic vinyl based compounds are usable singly, or in combination with at least two kinds.

Another copolymerizable monomer is not specifically limited, but a chained vinyl compound, a chained conjugated diene compound and so forth are usable. When using a chained conjugated diene, not only operability in the manufacturing process is excellent, but also the resulting alicyclic hydrocarbon based copolymer is excellent in strength.

Specific examples of chained vinyl compounds include chained olefin monomers such as ethylene, propylene, 1-butene, 1-pentene, 4-methyl-1-pentene and so forth; nitrile based monomers such as 1-cyanoethylenes(acrylonitrile), 1-cyano 1-methyl ethylene(meth-acrylonitrile), 1-cyano-1-chloroethylene (α-chloroacrylonitrile) and so forth; (meth)acrylic acid ester based monomers such as 1-(methoxycarbonyl)-1-methylethylene(methacrylic acid methyl ester), 1-(ethoxycarbonyl)-1-methyl ethylene(methacrylic acid ethyl ester), 1-(propoxycarbonyl)-1-methyl ethylene(methacrylic acid propyl ester), 1-(butoxycarbonyl)-1-methyl ethylene(methacrylic acid butyl ester), 1-methoxycarbonyl ethylene(acrylic acid methyl ester), 1-ethoxycarbonyl ethylene(acrylic acid ethyl ester), 1-propoxycarbonyl ethylene(acrylic acid propyl ester), 1-butoxycarbonyl ethylene(acrylic acid butyl ester) and so forth; and unsaturated fatty acid based monomers such as 1-carboxyethylene(acrylic acid), 1-carboxy-1-methyl ethylene(methacrylic acid), maleic anhydride and so forth. Among them, chained olefin monomers are preferable, and ethylene, propylene, and 1-butene are specifically preferable.

Examples of the chained conjugated diene include 1,3-butadiene, isoprene, 2,3-dimethyl-1,3-butadiene, 1,3-pentadiene, 1,3-hexadiene and so forth. Among these chained vinyl compounds and chained conjugated dienes, the chained conjugated dienes are preferable, and butadiene and isoprene are specifically preferable. These chained vinyl compounds and chained conjugated dienes are usable singly, or in combination with at least two kinds.

Polymerization reaction such as radical polymerization, anionic polymerization, cationic polymerization or the like is not specifically restricted, but the anionic polymerization method is preferable in consideration of easy polymerization operability and easiness in hydrogenation reaction in a post-process, and mechanical strength of the finally obtained hydrocarbon based copolymer.

In the case of anionic polymerization, methods such as a block polymerization method, a solution polymerization method and a slurry polymerization method are usable in the presence of an initiator in the temperature range of 0-200° C., preferably in the temperature range of 20-100° C., and more preferably in the temperature range of 20-80° C., but the solution polymerization method is preferable in consideration of removal of reaction heat. In this case, an inert solvent capable of dissolving a polymer and its hydride is employed. Examples of the inert solvent used via solution reaction include aliphatic hydrocarbons such as n-butane, n-pentane, iso-pentane, n-hexane, n-heptane, iso-octane and so forth; alicyclic hydrocarbons such as cyclopentane, cyclohexane, methylcyclopentane, methylcyclohexane, decalin and so forth; and aromatic hydrocarbons such as benzene, toluene and so forth. Usable examples of the initiator for the above-described anionic polymerization include monoorganic lithium such as n-butyl lithium, sec-butyl lithium, t-butyl lithium, hexyllithium, phenyllithium or the like; and polyfunctional organic lithium compound such as dilithiomethane, 1,4-diobutane, 1,4-dilithio-2-ethylcyclohexane or the like.

In cases where hydrogenation reaction for a carbon-carbon double bond in an unsaturated ring such as an aromatic ring and a cycloalkene ring and an unsaturated bond in the main chain in a copolymer before the hydrogenation is conducted, the present invention is not specifically limited to a reaction method and a reaction mode, followed by introduction of a commonly known method, but preferable is a hydrogenating method in which a hydrogenation rate can be increased, and a polymer chain break reaction produced simultaneously with the hydrogenation reaction is reduced. For example, provided is a method employing a catalyst containing at least one metal selected from the group consisting of nickel, cobalt, iron, titanium, rhodium, palladium, platinum, ruthenium and rhenium in an organic solvent. The hydrogenation reaction is usually carried out at a temperature of 10-250° C., but for the reason that a polymer chain break reaction produced simultaneously with the hydrogenation reaction can be reduced, a temperature of 50-200° C. is preferable, and a temperature of 80-180° C. is more preferable. Further, hydrogen pressure is usually 0.1-30 MPa, but in addition to the above-described reason, form the viewpoint of operability, the hydrogen pressure is preferably 1-20 MPa, and more preferably 2-10 MPa.

The hydrogenation rate of a hydrogenated product obtained in this way is usually at least 90%, preferably at least 95%, and more preferably at least 97% for any of the carbon-carbon unsaturated bond in the main chain, the carbon-carbon double bond in the aromatic ring and the carbon-carbon double bond in the unsaturated ring in the measurement in accordance with ¹H-NMR. When the hydrogenation rate is low, low birefringence, thermal stability and so forth of the resulting copolymer are lowered.

A method of collecting the hydrogenated product after terminating the hydrogenation reaction is not specifically limited. Conventionally, after removing a hydrogenation catalyst residue by a process such as filtration, centrifugal separation or the like, usable are a method of removing a solvent from the hydrogenated product solution by directly drying, and another method of putting the hydrogenated product solution into a poor solvent for the hydrogenated product to solidify the hydrogenated product.

It is preferable in view of durability that a Ni coat is provided on the surface of a sub-master made of the thermoplastic resin to provide a releasing agent.

### <<Base Material>>

Base material 26 is a backing material which means that even though insufficient strength is obtained with only molding section 22 in sub-master 20, strength of sub-master 20 is increased by attaching a resin onto the base material to conduct molding many times.

As base material 26, any material capable of providing flatness such as fused quartz, silicon wafer, metal, glass, a resin and so forth may be used.

From a viewpoint of transparency, that is, in consideration of being possible to make sub-master 20 to be exposed to UV radiation from any one of the upper and lower sides, a transparent material such as quartz, glass, a resin or the like is preferable. As the transparent material, any of a thermoplastic resin, a thermosetting resin and a UV curable resin may be used, and the effect to lower a linear expansion coefficient via addition of particles into the resin may be produced. When such a resin is used, it is easy to be released during releasing since the resin bends more than glass, but there appears a drawback such that transferring can not be clearly made by deforming the shape when heat is generated during exposure to UV radiation, since the resin has a large linear expansion coefficient.

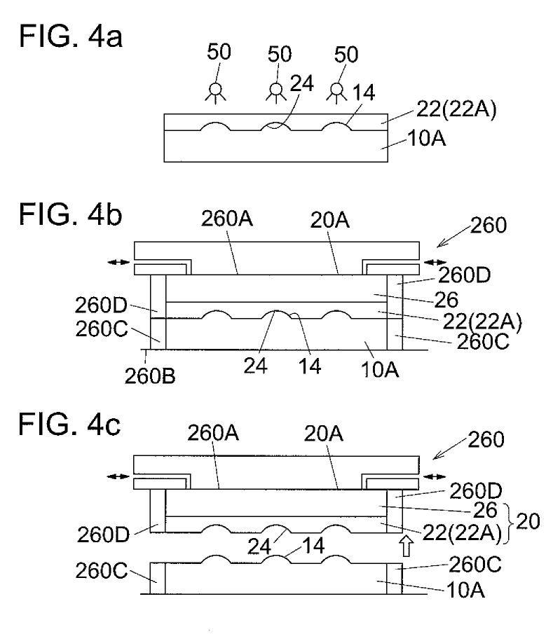

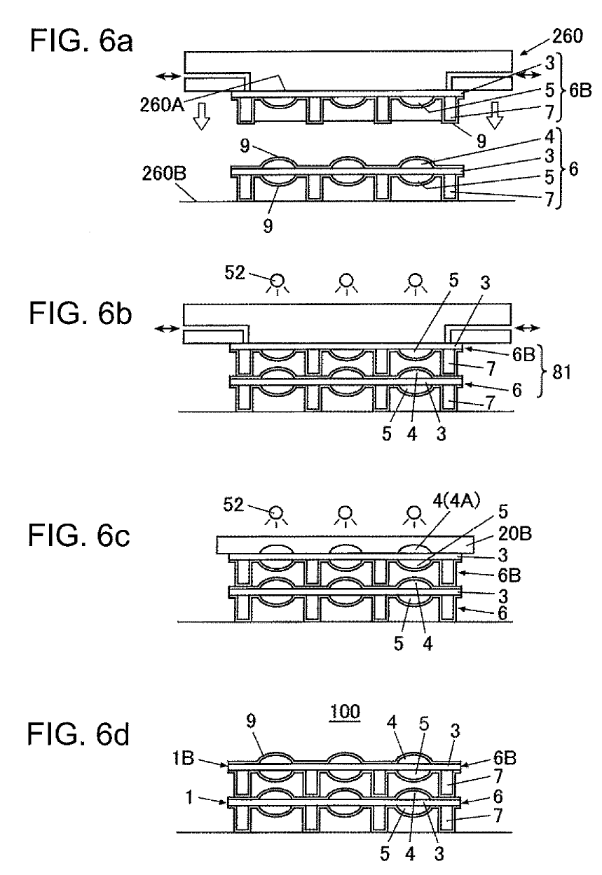

Referring to FIGS. 4a-4c each, FIGS. 5a-5h each, and FIGS. 6a-6d each, described will be a method of manufacturing wafer lenses 1 and 1B, and wafer lens assembly 100

First, sub-master 20 is molded with master 10A. Herein, “master 10A” means a mother die by which “sub-master 20” to mold “lens section 5” is molded, distinguishing from “master” (unshown) by which “sub-master 20B” to mold “lens section 4” is molded.

As shown in FIG. 4a, resin 22A is coated on master 10A; convex portions 14 of master 10A are transferred to resin 22A; and resin 22A is cured to form plural concave portions 24 with respect to resin 22A. By doing this, molding section 22 is formed.

Resin 22A may be thermo-curable, photo-curable, or volatilization-curable {HSQ (hydrogen silsesquioxane or the like) to cure via the volatilization of a solvent}. When precisely molding transferability is largely desired, preferable is molding via UV curing or with volatilization-curable resin exhibiting less influence of thermal expansion of resin 22A because of no heat applied during curing, but the present invention is not limited thereto. No large force for resin 22A exhibiting a good releasing property from master 10A after curing has to be applied during peeling, whereby no molded optical surface configuration or the like is carelessly deformed, leading to preferred results.

In cases where resin 22A (material for molding section 22) and resin 5A (material for lens section 5) are curable resins, optical surface configuration (convex portion 14) of master 10A is preferably designed in consideration of curing shrinkage of resin 22A and curing shrinkage of resin 5A.

When coating resin 22A on master 10A, a spray coating method, a spin coating method or the like is employed. In this case, resin 22A may be coated while being vacuumed. When resin 22A is coated while being vacuumed, resin 22A can be cured without mixing air bubbles in resin 22A.

Further, the above-described releasing agent may be coated on the surface of master 10A to improve a releasing property.

When coating a releasing agent, master 10A is subjected to a surface modification treatment Specifically, OH groups appear to be raised on the surface of master 10A. As a method of conducting a surface modification treatment, any of methods such as a UV ozone washing method, an oxygen plasma ashing method and so forth may be allowed to be used, as long as OH groups appear to be raised on the surface of master 10A.

In cases where resin 22A is a photo-curable resin, light source 50 placed above master 10A is turned on for light exposure.

Examples of light source 50 include a high-pressure mercury lamp, a metal halide lamp, a xenon lamp, a halogen lamp, a fluorescent lamp, a black light, a G lamp, a F lamp and so forth, and light source 50 may be a line-shaped light source or may be a point-shaped light source. The high pressure mercury lamp is a lamp having a narrow spectrum at 365 nm and 436 nm. The metal halide lamp is a kind of a mercury-vapor lamp, and its output in an ultraviolet region is several times higher than that of the high-pressure mercury lamp. The xenon lamp is a lamp having a spectrum nearest to sunlight. The halogen lamp contains a lot of light having long wavelengths, and is a lamp mostly emitting near-infrared light. The fluorescent lamp has equal exposure intensity with respect to three primary colors of light. The black light has a peak top at 351 nm, and emits near-ultraviolet light having a wavelength of 300-400 nm.

In the case of light exposure from light source 50, plural line-shaped or spot-shaped light sources 50 may be placed in the form of a lattice in such a way that light reaches at once the entire surface of resin 22A, or a line-shaped or spot-shaped light source 50 may be scanned parallel to the surface of resin 22A in such a way that light reaches resin 22A sequentially. In this case, preferably, luminance distribution or illumination (intensity) distribution during light exposure is measured to control the number of times of light exposure, an amount of light exposure, and light exposure time based on the measuring results.

After photo-curing resin 22A (after preparation of sub-master 20), sub-master 20 may be subjected to a post-cure (heat treatment). When the post-cure is conducted, resin 22A in sub-master 20 can be completely cured, and die lifetime of sub-master 20 can be extended.

In cases where resin 22A is a thermosetting resin, resin 22A is heated while controlling heating temperature and heating time in the optimal range. Resin 22A can be also molded by each of methods such as an injection molding method, a press molding method, a method of cooling after light exposure, and so forth.

As shown in FIG. 4b, base material 26 is placed on the back surface (the surface opposite to concave portions 24) of molding section 22 (resin 22A) to back up molding section 22.

Base material 26 may be fused quartz, or may be a glass plate, and sufficient bending strength and UV transmittance are largely desired. In order to enhance adhesiveness of molding section 22 to base material 26, a treatment of coating a silane coupling agent or the like may be conducted on base material 26.

In addition, after convex portions 14 of master 10A is transferred onto resin 22A, and resin 22A is cured (that is, after molding section 22 is formed), an adhesive is employed when providing base material 26.

In contrast, before convex portions 14 of master 10A is transferred onto resin 22A, and resin 22A is cured, base material 26 maybe arranged to be backed (being backed up at room temperature). In this case, without using an adhesive, base material 26 adheres to resin 22A via adhesive force of resin 22A, or a coupling agent is coated onto base material 26 to enhance the adhesive force, whereby base material 26 is attached onto resin 22A.

Further, when molding section 22 (resin 22A) is backed up with base material 26, employing commonly known vacuum chuck apparatus 260, while sucking and holding base material 26 on sucking surface 260A of this vacuum chuck apparatus 260, sucking surface 260A is placed parallel to the molding surface of convex portions 14 of master 10A, and molding section 22 is preferably backed up with base material 26. By doing this, back surface 20A (the surface on the side of base material 26) of sub-master 20 becomes parallel to the molding surface of convex portions 14 of master 10A, so that the molding surface of concave portions 24 of sub-master 20 becomes parallel to back surface 20A. Accordingly, as described later, when molding lens sections 5 with sub-master 20, since the reference surface of sub-master 20, that is, back surface 20A can be placed parallel to the molding surface of concave portions 24, it is possible to prevent lens sections 5 from causing decentering and fluctuating thickness, whereby the profile accuracy of lens sections 5 can be improved. Further, since sub-master 20 is sucked and held by vacuum chuck apparatus 260, sub-master 20 can be attached or detached via operation of only ON/OFF for vacuum evacuation. Accordingly, sub-master 20 can be arranged to be easily provided.

Here, “back surface 20A is parallel to the molding surface of concave portions 24” means specifically “back surface 20A is vertical to the central axis on the molding surface of concave portions 24”.

Further, sub-master 20 is preferably formed via curing while backing up, but may be formed via curing before backing up. Examples of the method of curing while backing up with base material 26 include a method of introducing one in which resin 22A is filled in between master 10A and base material 26 into a baking furnace employing a thermoplastic resin as resin 22A in the situation where resin 22A is filled in between master 10A and base material 26 into a baking furnace; another method by which resin 22A is exposure to UV light from the side of base material 26 in the situation where resin 22A is filled in between master 10A and base material 26, employing a UV curable resin as resin 22A together with a substrate exhibiting UV transparency as substrate 26; and so forth.

Further, sucking surface 260A of the vacuum chuck apparatus 260 is preferably formed of a ceramic material. In this case, since hardness of sucking surface 260A becomes high, sucking surface 260A is difficult to be damaged because of attachment and detachment of sub-master 20 (base material 26), high surface accuracy of sucking surface 260A can be maintained. Further, as such a ceramic material, silicon nitride or SIALON is preferably usable. In this case, because of a small linear expansion coefficient of 1.3 ppm, high flatness of sucking surface 260A can be maintained with respect to temperature change.

In addition, in the present embodiment, as a method of making sucking surface 260A placed parallel to the molding surface of convex portions 14 of master 10A, the following methods are utilized.

First, the front and back surfaces of master 10A are placed parallel to each other with high precision. By doing this, as to master 10A, the molding surface of convex portions 14 becomes parallel to the reverse surface of it.

Further, reference members 260C and 260D are arranged to be placed for supporting surface 260B to support master 10A from the back surface side (the surface opposite to convex portions 14) and sucking surface 260A, respectively. Herein, as to the configuration of each of these reference members 260C and 260D, when master 10A and sub-master 20 are brought into contact with each other in the situation where supporting surface 260B and sucking surface 260A are parallel to each other, the foregoing configuration is designed to be a configuration in which they come in contact with each other without being shaky.

With this configuration, when reference member 260C and 260D are brought into contact with each other, supporting surface 260B of master 10A as well as molding surface of convex portions 14 of master 10A becomes parallel to sucking surface 260A.

However, in the above-described methods, the reference member may be provided to at least one of supporting surface 260B and sucking surface 260A. For example, in cases where the reference member is provided to only supporting surface 260B, the configuration of the reference member may be a configuration in which the reference member comes in contact with sucking surface 260A without being shaky when master 10A and sub-master 20 are brought into contact with each other in the situation where supporting surface 260B and sucking surface 260A are parallel to each other. Similarly, in cases where the reference member is provided to only sucking surface 260A, the configuration of the reference member may be a configuration in which the reference member comes in contact with supporting surface 260B without being shaky when master 10A and sub-master 20 are brought into contact with each other in the situation where supporting surface 260B and sucking surface 260A are parallel to each other.

As shown in FIG. 4c, when molding section 22 and base material 26 are released from master 10A to form sub-master 20.

When employing a resin such as PDMS (poly dimethyl siloxane) as resin 22A, a releasing agent is further coated on the surface of the Ni coat, since a releasing property with master 10 is excellent, large force is not used for peeling from master 10, and it is good that there is no possibility that the molded optical surface is distorted.

In addition, sub-master 20B (refer to FIG. 5e) having negative configuration concave portions 24 corresponding to lens section 4 is also formed with a mater (unshown) by the similar procedure.

From this, preparation of sub-master 20 (the first molding die) corresponding to lens section 5 and sub-master 20B (the second molding die) corresponding to lens section 4 is completed.

Lens sections 4 and 5 will be subsequently molded.

First, resin 5A is filled in between glass substrate 3 and sub-master 20 for curing, Specifically, as shown in FIG. 5a, resin 5A is coated on glass substrate 3, and resin 5A is covered by pressing glass substrate 3 on which resin 5A is covered, from the upper side with sub-master 20.

When pressing with sub-master 20 from the upper side, pressing may be carried out while vacuuming. When pressing is carried out while, resin 5A can be cured without mixing air bubbles in resin 5A.

In place of glass substrate 3 on which resin 5A is coated, which is pressed by sub-master 20 from the upper side, though being unshown, resin 5A is filled in concave portions 24 of sub-master 20, and resin 5A may be cured while pressing resin 5A which has been filled in with glass substrate 3 from the upper side.

When pressing glass substrate 3, a structure in which glass substrate 3 and sub-master 20 are aligned is preferably provided. When glass substrate 3 is in a circular form, for example, it is preferable to form a D cut, an I cut, a marking, a notch or the like. Glass substrate 3 may in the polygonal form, and in this case, an alignment with sub-master 20 may be easily done.

When curing resin 5A, since resin 5A is a photo-curable resin, it may be exposed to light from the side of sub-master 20 after turning on light source 52 placed on the upper side of sub-master 20; may be exposed to light from the side of glass substrate 3 after turning on light source 54 placed on the lower side of glass substrate 3; or maybe exposed to light from the both sides of sub-master 20 and glass substrate 3 after turning on both light sources 52 and 54 at the same time (refer to FIG. 5b).

Usable examples of light sources 52 and 54 include a high-pressure mercury lamp, a metal halide lamp, a xenon lamp, a halogen lamp, a fluorescent lamp, a black light, a G lamp, a F lamp and so forth, and each of them may be a line-shaped light source or may be a point-shaped light source.

In the case of light exposure from light sources 52 and 54, plural line-shaped or spot-shaped light sources 52 and 54 may be arranged to be placed in the form of a lattice in such a way that light reaches resin 5A at the same time, or line-shaped or spot-shaped light source 52 and 54 maybe scanned parallel to sub-master 20 and glass substrate 3 in such a way that light reaches resin 5A sequentially. In this case, preferably, luminance distribution or illumination (intensity) distribution is measured during light exposure, and then the number of times of light exposure, an amount of light exposure, and light exposure time are controlled, based on the measurement results.

Lens section 5 is formed by curing resin 5A.

Thereafter, before releasing sub-master 20, preheating (the first heating step) is carried out once. Specifically, it is conducted at a temperature lower than the after-mentioned post-cure treatment temperature for a short duration (for example, at 80° C. for 10 minutes). When preheating is conducted before releasing, and the after-mentioned post-cure treatment is conducted after releasing, transfer accuracy of the surface configuration of lens section 5 becomes excellent. Further, even though UV exposure time is reduced to the amount of roughly 50%, the same surface transfer precision as in the case of 100% of UV exposure is obtained. As a result, reduction of UV exposure time is possible to be reduced, whereby manufacturing efficiency is improved by energy saving of electric power, longer operating time of a UV lamp, and reduction of molding apparatus occupation time.

Next, as shown in FIG. 5c, lens section 5 and glass substrate 3 are released from sub-master 20 (the first releasing step). Herein, in cases where resin 5A is specifically an epoxy resin among photo-curable resins, warpage of glass substrate 3 is difficult to be produced during releasing since reaction has not been completed even though the resin is exposed to light.

As shown in FIG. 5d, spacer 7 is provided.

Spacer 7 is a member in the form of a disk, which is formed of glass or transparent resin, opening section 71 is formed at the position corresponding to lens sections 4 and 5 in wafer lens 1 (lens sections 4 and 5 are designed to be exposed from opening section 71).

Then, spacer 7 is placed with respect to lens section 5. Specifically, an adhesive (unshown) is coated on the upper surface of glass substrate 3 or the lower surface of spacer 7 to place spacer 7 in such a way that lens section 5 is exposed from opening section 71.

Next, as shown in FIG. 5e, in the situation where spacer 7 is attached, the system is turned upside down. Still having the system being turned upside down, resin 4A is further coated on glass substrate 3, and glass substrate 3 on which resin 4A is coated is pressed with sub-master 20B from the upper side to cure resin 4A.

As to curing of resin 4A, since resin 4A is also a photo-curable resin, as described above, it is exposed to light source 52 from the upper portion of sub-master 20B to cure it (refer to FIG. 5f).

Similarly, also in the case of formation of lens section 4, in order to avoid mixing air bubbles in resin 4A, resin 4A may be filled in while vacuuming when pressing with sub-master 20B. Further, though being unshown, resin 4A is filled in concave portions 24 of sub-master 20B, and resin 4A may be cured while pressing resin 4A having been filled in with glass substrate 3 from the upper side.

Lens section 4 is formed by curing resin 4A.

Thereafter, before releasing sub-master 20B, preheating (the second heating step) is carried out once. Similarly to the above-described, preheating in this case is conducted at a temperature lower than the after-mentioned post-cure treatment temperature for a short duration. By doing this, transfer accuracy of the surface configuration of lens section 4 becomes excellent.

Next, as shown in FIG. 5g, sub-master 20B is released from lens section 4 (the second releasing step). Herein, in cases where resin 4A is specifically an epoxy resin among photo-curable resins, warpage of glass substrate 3 is difficult to be produced during releasing since reaction has not been completed even though the resin is exposed to light.

Then, a post-cure treatment is conducted all at once for lens sections 4 and 5 on the both surfaces after releasing to conduct curing while heating (post-cure treatment step). The post-cure treatment is conducted, for example, at 150° C. for one hour. By doing this, the second molding 6 (hereinafter, referred to simply as “molding 6”) composed of lens sections 4 and 5, glass substrate 3 and spacer 7 is formed. Herein, since warpage of glass substrate 3 is not produced even after light exposure and releasing as described above, and lens sections 4 and 5 on the both surfaces are subjected to a post-cure treatment all at once in a state of glass substrate 3 exhibiting flatness, warpage of glass substrate 3 is not produced after conducting a post-cure treatment, whereby lens sections 4 and 5 can be completely cured.

Next, as shown in FIG. 5h, antireflective film 9 is formed on the surface of molding 6 (antireflective film forming step). First, molding 6 is placed in a vacuum evaporator (unshown); pressure inside the vacuum evaporator is reduced to a predetermined pressure (for example, 2×10⁻³ Pa); and molding 6 a is heated up to a predetermined temperature (for example, 240° C.) with a heater placed above the vacuum evaporator.

Thereafter, employing an evaporation source constituting first layer 91 of antireflective film 9, first layer 91 is formed. Specifically in this case, the film forming temperature is maintained in the range of from −40° C. to +40° C. with respect to the melting temperature of a conductive paste to be melted in a reflow treatment.

For example, when a (Ta₂O₅+5% TiO₂) film is formed as first layer 91, employing 0A600 (produced by Optorun Co., Ltd.) as an evaporation source, the evaporation source may be vaporized via electron gun heating. During evaporation, O₂ gas is introduced until the pressure inside the vacuum evaporator reaches 1.0×10⁻² Pa, and a film is preferably formed while controlling the evaporation rate at 0.5 nm/sec. Further, when the melting temperature of a conductive paste to be melted in a reflow treatment is, for example, 240° C., the film forming temperature (temperature inside the evaporator) is maintained in the range of 200-280° C.

Thereafter, in order to form first layer 91 on the both surfaces of molding 6, molding 6 is reversed by a reversing mechanism inside the evaporator to form first layer 91 on the back surface in the same manner as described above (the film formation of second layer 92 on the back surface is also conducted in the same manner as in, the foregoing).

Thereafter, employing an evaporation source continuously to form second layer 92 on first layer 91, second layer 92 is formed. In this case, similarly to the case of formation of first layer 91, the film forming temperature is maintained in the range of from −40° C. to +40° C. with respect to the melting temperature of a conductive paste to be melted in a reflow treatment.

For example, when an SiO₂ film is used as second layer 92, O₂ gas is introduced until the pressure inside a vacuum evaporator reaches 1.0×10⁻² Pa; and a film is preferably formed while controlling the evaporation rate at 0.5 nm/sec. Further, when the melting temperature of a conductive paste to be melted in a reflow treatment is, for example, 240° C., the film forming temperature (temperature inside the evaporator) is maintained in the range of 200-280° C.

By conducting the above-described steps, antireflective film 9 can be formed on the surface of molding 6, wafer lens 1 in which lens sections 4 and 5 are formed on the both surfaces of glass substrate 3 is manufactured.

In addition, in the above-described procedures, antireflective film 9 is designed to be formed via evaporation after conducting a post-cure treatment, but without conducting a post-cure treatment thereof, a post-cure treatment may be simultaneously conducted during formation of antireflective film 9 via evaporation (in an evaporator). Specifically, during evaporation, vacuuming usually takes 40 minutes, but if this is extended further to 60 minutes, a post-cure treatment can be simultaneously conducted during formation of antireflective film 9. In this way, when a post-cure treatment is simultaneously conducted during formation of antireflective film 9, not only the steps are reduced, but also a resin can be cured in oxygen-free atmosphere, whereby a coloring problem can be inhibited.

On the other hand, taking the same procedure as in FIGS. 5a-5d, the first molding 6B (hereinafter, referred to simply as “molding 6B”) composed of glass substrate 3, lens section 5 and spacing 7 is formed (refer to FIG. 6a). A post-cure treatment and formation of antireflective film 9 are to be done for molding 6B. In addition, any of a step of forming molding 6 and another step of forming molding 6B may be conducted first.

Next, as shown in FIG. 6a, molding 6 is placed on supporting surface 260B in such a way that the side of spacer 7 of molding 6 is the lower plane. The fiat surface on the side where lens section 5 is not provided is sucked and held by sucking surface 260A of vacuum chuck apparatus 260 in such a way that the side of spacer 7 of molding 6B is also the lower plane. Vacuum chuck apparatus 260 is the same vacuum chuck apparatus 260 having been used during molding of sub-master 20 described above. Since sucking surface 260A is maintained in high flat surface accuracy, and the surface on the side where lens section 5 in molding 6B is not provided is also the flat surface, molding 6B can be sucked and held in a high flatness state. Further, it is made of fused glass exhibiting high transparency with respect to light to cure a resin.

As shown in FIG. 6b, sucking surface 260A is designed to be parallel to the molding plane of lens section 4 in molding 6, and molding 6 is bonded to molding 6B to form bonding body 81 (the first bonding step). In this case, an adhesive is coated on the lower surface of spacer 7 in molding 6B or the upper surface of glass substrate 3 in molding 6; spacer 7 is placed in glass substrate 3; and the system is exposed to light source 52 from the upper side of vacuum chuck apparatus 260 for bonding.

As shown in FIG. 6c, resin 4A is coated on glass substrate 3 in molding 6B, and glass substrate 3 on which resin 4A is coated is pressed with sub-master 20B from the upper side to cure resin 4A.

As for curing of resin 4A, similarly to FIG. 5f, since resin 4A is a photo-curable resin, as described above, the system is expected to light source 52 from the upper side of sub-master 20B for curing.

Similarly to also the case of formation of lens section 4, in order to avoid mixing air bubbles in resin 4A, resin 4A may be filled in while vacuuming, when pressing with sub-master 20B. Further, being unshown, resin 4A is filled in concave portions 24 of sub-master 20, and resin 4A may be cured while pressing resin 4A which has been filled in with glass substrate 3 from the upper side.

Lens section 4 is formed by curing resin 4A.

Thereafter, in order to improve transfer accuracy of the surface configuration of lens section 4, preheating is preferably conducted once, before releasing sub-master 20B. Preheating in this case is also conducted at a temperature lower than the after-mentioned post-cure treatment temperature for a short duration in the same manner as described above.

Next, as shown in FIG. 6d, sub-master 20B is released from lens section 4. After releasing, lens section 4 is subjected to a post-cure treatment for heat-curing. The post-cure treatment is conducted, for example, at 150° C. for one hour.

Finally, antireflective film 9 is formed on the surface of lens section 4 in molding 6B by the same procedure as in FIG. 5h. Further, herein, formation of antireflective film 9 and a post-cure treatment are conducted at the same time, but the foregoing post-cure treatment step may be omitted.

As described above, prepared is wafer lens assembly 100 in which wafer lens 1B is layered on wafer lens 1 via spacer 7.

In the first embodiment of the present invention, after filling resin 5A in to cure it on one surface of glass substrate 3, it is released, and subsequently, lens section 4 and 5 on both surfaces of glass substrate 3 are subjected to a post-cure treatment all at once. That is, resins 4A and 5A are not completely cured during releasing, and warpage of glass substrate 3 has not been produced. For this reason, lens sections 4 and 5 on the both surfaces are subjected to a post-cure treatment all at once in the situation where glass substrate 3 is flat, whereby lens sections 4 and 5 can be completely cured without conducting a post-cure treatment.

Further, resins 4A and 5A are cured with respect to each surface of glass substrate 3, whereby reduction of curing time can be made. Furthermore, since resins 4A and 5A are not completely cured in the situation before a post-cure treatment, but resins 4A and 5A on the both surfaces are completely cured all at once during the post-cure treatment, reduction of curing time can be made also in this case. In addition, when resins 4A and 5A are exposed to light for curing, since each of them is exposed to light from one surface of glass substrate 3, light exposure apparatus (light sources 52 and 54) can be also simplified.

In addition, it is described in the first embodiment that two molding dies are prepared, and lens sections as optical members are formed on both surfaces of a glass substrate, but the present invention is not limited thereto, and the first embodiment is applicable for those in which lens sections are formed only on one surface of a glass substrate.

That is, when a method of manufacturing a wafer lens possesses a filling step of preparing a molding die having plural molding surfaces corresponding to optical surface configuration of an optical member to fill a photo-curable resin in between one surface of a substrate and a molding surface of a molding die; a photo-curing step of exposing a photo-curable resin to light to accelerate photo-curing; a heating step of conducting a heat treatment for the photo-curable resin having been cured in the photo-curing step; and a releasing step of releasing the molding die from the photo-curable resin after conducting the heating step, transfer of the surface configuration of lens sections becomes excellent.

Further, reduction of curing time can be made by conducting a post-cure treatment for the optical member having been formed on the one surface of the substrate after conducting the releasing step.

Further, in the first embodiment, an example of conducting a post-cure treatment for lens sections 4 and 5 of the both surfaces al at once has been described, but a post-cure treatment is conducted during formation of lens section 4, and another post-cure treatment may be subsequently conducted during formation of lens section 5.

### The Second Embodiment

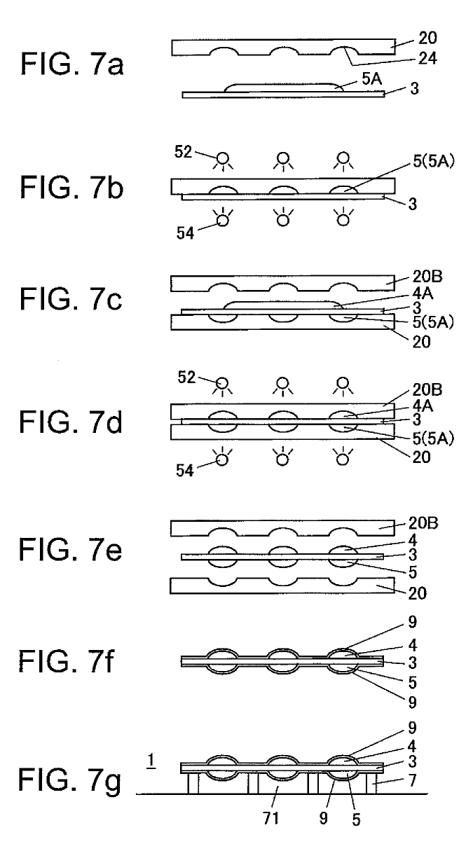

The second embodiment, in which resins 4A and 5A are filled in onto both surfaces of glass substrate 3; simultaneously exposed to light for curing and subsequently released, and lens sections 4 and 5 are subjected to a post-cure treatment all at once, differs from the first embodiment. Next, a method of manufacturing wafer lens 1 will be described referring to FIGS. 7a-7g.

First, as shown in FIGS. 7a-7b, the same procedure as in FIGS. 5a-5b is taken, resin 5A is filled in onto one surface of glass substrate 3 to form lens 5.

Thereafter, as shown in FIG. 7c, without releasing lens section 5 and glass substrate 3 from sub-master 20, the resulting as it is has been turned upside down. After that as it is has been turned upside down, resin 4A is further coated on glass substrate 3, and glass substrate 3 on which resin 4A is coated is pressed with sub-master 20B from the upper side to cure resin 4A.

As for curing of resin 4A, since resin 4A is a photo-curable resin, as described above, resin 4A may be cured by exposing it to each of light sources 52 and 54 from the upper side of sub-master 20B or from the lower side of sub-master 20, or both light sources 52 and 54 may be used.

In addition, in this case, since not only resin 4A but also resin 5A can be cured, resin 5A may not be cured specifically in FIG. 7b, and a curing step in FIG. 7b may be omitted.

Similarly to the case of formation of lens section 4, in order to avoid mixing air bubbles in resin 4A, resin 4A may be filled in while vacuuming, when pressing with sub-master 20B. Further, though being unshown, resin 4A is filled in concave portions 24 of sub-master 20B, and resin 4A may be cured while pressing resin 4A having been filled in with glass substrate 3 from the upper side.

Lens section 4 is formed by curing resin 4A (refer to the molding step: FIG. 7d).

Thereafter, before releasing sub-masters 20 and 20B, preheating (the second heating step) is carried out once. Specifically, it is conducted at a temperature lower than the after-mentioned post-cure treatment temperature for a short duration (for example, at 80° C. for 10 minutes). Transfer accuracy of the surface configuration of lens sections 4 and 5 becomes excellent by conducting preheating before releasing, and conducting the after-mentioned post-cure treatment after releasing. Further, as described above, even though UV exposure time is reduced to the amount of roughly 50%, the same surface transfer precision as in the case of 100% of UV exposure is obtained. As a result, reduction of UV exposure time is possible to be reduced, whereby manufacturing efficiency is improved by energy saving of electric power, longer operating time of a UV lamp, and reduction of molding apparatus occupation time.

Next, as shown in FIG. 7e, sub-master 20B on one side is released from lens section 4, and sub-master 20 on another side is released from lens section 5 (the third releasing step). After releasing, lens sections 4 and 5 are subjected to a post-cure treatment all at once for heat-curing (post-cure treatment step). The post-cure treatment step is conducted, for example, at 150° C. for one hour.

After the post-cure treatment, antireflective film 9 is formed on each of the surfaces of lens sections 4 and 5 by the same procedure as in FIG. 5h (refer to antireflective film: FIG. 7f). Also in this case, formation of antireflective film 9 and a post-cure treatment are simultaneously conducted, but the above-described post-cure treatment step may be omitted.

Further, as shown in FIG. 7g, lens section 5 is placed on spacer 7. Specifically, an adhesive is coated on the lower surface of glass substrate 3 or on the upper surface of spacer 7 to place glass substrate 3 on spacer 7. By doing those as described above, prepared is wafer lens 1 in which lens sections 4 and 5 are formed on both surfaces of glass substrate 3.

In addition, in FIGS. 7f-7g, antireflective film 9 is formed on each of lens sections 4 and 5 after a post-cure treatment, but without any limitation to this order, glass substrate 3 is first placed on spacer 7 after releasing to mold molding 6 composed of lens sections 4 and 5, glass substrate 3 and spacer 7 in advance, and subsequently, antireflective film 9 may be formed on each of lens sections 4 and 5 in molding 6. And, a post-cure treatment is simultaneously conducted during formation of antireflective film 8, but the above-described post-cure treatment step may be omitted.

Further, also in the second embodiment, wafer lens assembly 100 can be manufactured by the same procedure as in FIGS. 6a-6d relating to the first embodiment by utilizing the above-described wafer lens 1.

In the second embodiment of the present invention, sub-masters 20 and 20B on the both surfaces are released after resins 4A and 5A are filled in onto both surfaces of glass substrate 3, and then lens sections 4 and 5 on both surfaces of glass substrate 3 are subjected to a post-cure treatment all at once. Namely, resins 4A and 5A are not completely cured during releasing and warpage of glass substrate 3 has not been produced. Therefore; when lens section 4 and 5 on both surfaces are subjected to a post-cure treatment all at once in the situation where glass substrate 3 is flat, no warpage of glass substrate 3 appears even after conducting a post-cure treatment, whereby lens sections 4 and 5 can be completely cured.

### The Third Embodiment

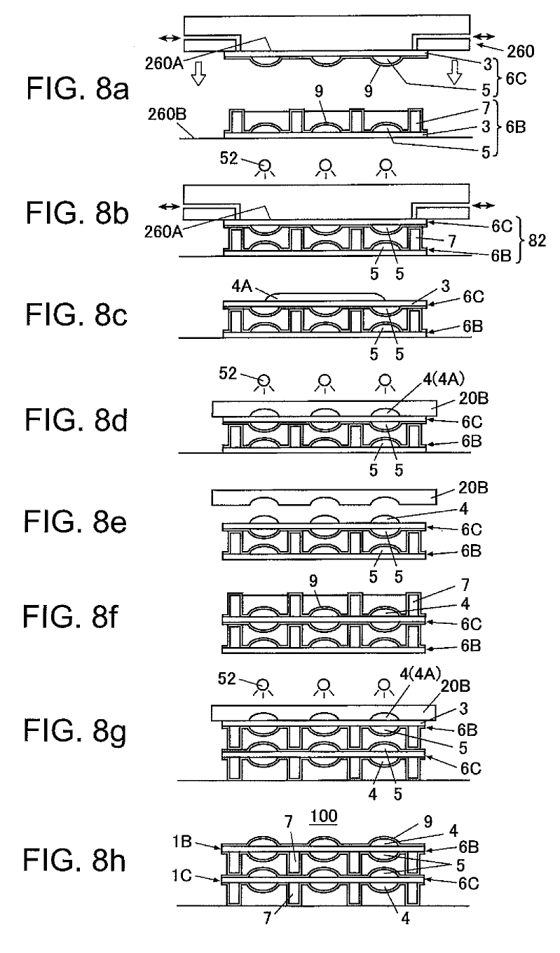

The method of manufacturing wafer lenses 1 and 1B, and wafer lens assembly 100 will be described referring to FIGS. 8a-8h.

In the above-described embodiment, the case where wafer lens 100 is prepared by bonding molding 6B (the first molding in which lens section 5 is placed only on one surface) to molding 6 (the second molding in which lens sections 4 and 5 are placed on both surfaces) has been described, but in the case of the third embodiment, wafer lens assembly 100 is prepared by bonding molding 6 to the same molding 6B as in the first embodiment by utilizing the second molding 6C (hereinafter, referred to simply as “molding 6C”) in which lens section 5 is placed only on one surface, in place of molding 6 in the first embodiment.

First, the same procedure as in FIGS. 5a-5c is taken, and molding 6C composed of glass substrate 3 and lens section 5 is molded. And, a post-cure treatment and formation of antireflective film 9 are conducted for molding 6C (refer to FIG. 8a).

On the other hand, the same procedure as in FIGS. 5a-5d is taken, and molding 6B (the first molding) composed of glass substrate 3, lens section 5 and spacer 7 is molded. And, a post-cure treatment and formation of antireflective film 9 are conducted for molding 6B (refer to FIG. 8a).

As shown in FIG. 8a, molding 6B is placed on supporting surface 260B in such a way that spacer 7 is on the upper side, and the flat surface on the side where lens section 5 is not provided is on the lower side. As for molding 6C, the flat surface on the side where lens section 5 is not provided is sucked and held by sucking surface 260A of vacuum chuck apparatus 260. Vacuum chuck apparatus 260 is the same vacuum chuck apparatus 260 as one used during molding of the above-described sub-master 20. Sucking surface 260A maintains high surface accuracy, and since the surface on the side where lens section 5 in molding 6C is not provided is also a flat surface, molding 6C can be sucked and held in a state of high flatness.

As shown in FIG. 8b, sucking surface 260A is designed to be parallel to the molding surface of lens section 5 in molding 6B to produce bonding body 82 by bonding each of molding 6B and molding 6C. In this case, bonding is conducted by coating an adhesive (unshown) on the upper surface of spacer 7 in molding 6B or on the lower surface of glass substrate 3 in molding 6C; placing glass substrate 3 in molding 6C on spacer 7 in molding 6B; and exposing the system to light source 52 from the upper side of vacuum chuck apparatus 260.

As shown in FIG. 8c, resin 4A is coated on glass substrate 3 in molding 6C, and glass substrate 3 on which resin 4A is coated is pressed with sub-master 20B from the upper side to cure resin 4A.

As for curing of resin 4A, similarly to the above-described FIG. 5f, since resin 4A is a photo-curable resin, as described above, the system is exposed to light source 52 from the upper side of sub-master 20B for curing (refer to FIG. 8d).

Similarly to the case of formation of lens section 4, in order to avoid mixing air bubbles in resin 4A, resin 4A may be filled in while vacuuming when pressing with sub-master 20B. Further, though being unshown, resin 4A is filled in concave portions 24 of sub-master 20B, and resin 4A may be cured while pressing resin 4A having been filled in with glass substrate 3 from the upper side.

Resin 4A is cured to form lens section 4.

Next, as shown in FIG. 8e, sub-master 20B is released from lens section 4. After releasing, lens section 4 is subjected to a post-cure treatment for heat-curing. The post-cure treatment is conducted, for example, at 150° C. for one hour.

Further, as shown in FIG. 8f, spacer 7 is placed on glass substrate 3 in molding 6C. Specifically, an adhesive (unshown) is coated on the upper surface of glass substrate 3 or on the lower surface of spacer 7, and spacer 7 is placed on glass substrate 3.

Next, antireflective films 9 are formed on lens section 4 in molding 6C and the surface of spacer 7 by the same procedure as in FIG. 5h. Also in this case, formation of antireflective films 9 and a post-cure treatment are simultaneously conducted, but the foregoing post-cure treatment may be omitted

As shown in FIG. 8g, in an adhesive state of spacer 7, molding 6B and molding 6C are turned upside down. As to the resulting as it is, resin 4A is further coated on glass substrate 3 in molding 6B, and glass substrate 3 on which resin 4A is coated is pressed with sub-master 20B from the upper side to cure resin 4A.

As for curing of resin 4A, similarly to the foregoing FIG. 5f, since resin 4A is a photo-curable resin, the system is exposed to light source 52 from the upper side of sub-master 20B for curing, as described above.

Similarly to formation of lens section 4, in order to avoid mixing air bubbles in resin 4A, resin 4A may be filled in while vacuuming, when pressing with sub-master 20B. Further, though being unshown, resin 4A is filled in concave portions 24 of sub-master 20B, and resin 4A may be cured while pressing resin 4A having been filled in with glass substrate 3 from the upper side.

Resin 4A is cured to form lens section 4.

Next, as shown in FIG. 8h, sub-master 20B is released from lens section 4. After releasing, lens section 4 is subjected to apost-cure treatment for heat-curing. The post-cure treatment is conducted, for example, at 150° C. for one hour.

Finally, antireflective films 9 is formed on the surface of lens section 4 in molding 6B by the same procedure as in FIG. 5k Also in this case, formation of antireflective film 9 and a post-cure treatment are simultaneously conducted, but the foregoing post-cure treatment may be omitted

As described above, prepared is wafer lens assembly 100 in which wafer lens 1C is laminated on wafer lens 1B via spacer 7.

In addition, the present invention is not limited to the above-described embodiment, and changes can be appropriately made without departing from the scope of the invention.

In the above-described first embodiment, the case where wafer lens assembly 100 in which 2 wafer lenses are laminated has been described, but the case where a wafer lens assembly in which at least 3 wafer lenses are laminated can be manufactured can be also made by the same procedure as described above.

For example, as shown in FIG. 6d, after preparing wafer lens assembly 100 in which 2 wafer lenses 1 and 1B are laminated, the same molding (the first molding) as in FIG. 6a is molded in advance. And, after bonding molding 6B to wafer lens assembly 100, lens section 4 is formed on the upper surface of molding 6B by the same procedure as in FIGS. 6a-6d. A wafer lens assembly, in which at least 3 wafer lenses are laminated, can be manufactured by repeating these steps (FIGS. 6a-6d). Also in this case, since one surface of molding 6B is constantly a flat surface, bonding can be made in a state of high flatness by sucking and holding this flat surface from sucking surface 260A of vacuum chuck apparatus 260.

Further, in the second embodiment, it is mentioned that what is in FIG. 7b is turned upside down, but it may not be turned upside down. In this case, after filling resin 4A in sub-master 20B, glass substrate 3 and sub-master 20 in which resin 5A is filled are placed on this resin 4A, and then the system was exposed to light in the same manner as in FIG. 7d. Or, sub-master 20 is first placed in such a way that concave portions 24 in sub-master 20 are on the upper side, and resin 5A is filled in this sub-master 20 (one obtained by turning what is in FIG. 7a upside down). Next, resin 5A is cured via exposure to light (one obtained by turning what is in FIG. 7b upside down). Thereafter, resin 4A is coated on glass substrate 3 in the same manner as in FIG. 7c to cure resin 4A.

### EXPLANATION OF NUMERALS

1, 1B Wafer lens
3 Glass substrate (Substrate)
4A, 4B Resin
4, 5 Lens section (Optical member)
7 Spacer
9 Antireflective film
20 Sub-master (The first sub-master molding die)
20B Sub-master (The second sub-master molding die)
100 Wafer lens assembly
260 Vacuum chuck apparatus
260A Sucking surface

1. A method of manufacturing a wafer lens in which an optical member made of a photo-curable resin is formed on one surface of a substrate, comprising:
a filling step of preparing a molding die having plural molding surfaces corresponding to an optical surface configuration of the optical member to fill the photo-curable resin in between the one surface of the substrate and the molding surface of the molding die;
a photo-curing step of exposing the photo-curable resin to light to accelerate photo-curing;
a heating step of conducting a heat treatment for the photo-curable resin having been cured in the photo-curing step; and
a releasing step of releasing the molding die from the photo-curable resin after conducting the heating step.

2. The method of claim 1, comprising the step of:
conducting a post-cure treatment for the optical member having been formed on the one surface of the substrate after conducting the releasing step.

3. A method of manufacturing a wafer lens in which a first optical member made of a photo-curable resin is formed on one surface of a substrate, and a second optical member made of a photo-curable resin is formed on another surface of the substrate, comprising:
a preparation step of preparing a first molding die having plural molding surfaces corresponding to an optical surface configuration of the first optical member;
another preparation step of preparing a second molding die having plural molding surfaces corresponding to an optical surface configuration of the second optical member;
a first filling step of filling the photo-curable resin in between the one surface of the substrate and the molding surface of the first molding die;
a second filling step of filling the photo-curable resin in between the another surface of the substrate and the molding surface of the second molding die;
a first curing step of exposing the photo-curable resin having been filled in via the first filling step to accelerate curing;
a second curing step of exposing the photo-curable resin having been filled in via the second filling step to accelerate curing;
a first heating step of conducting a heat treatment after conducting the first curing step;
a second heating step of conducting a heat treatment after conducting the second curing step;
a first releasing step of releasing the first molding die from the photo-curable resin after conducting the first heating step; and
a second releasing step of releasing the second molding die from the photo-curable resin after conducting the second heating step.

4. The method of claim 3, comprising the step of:
conducting a post-cure treatment for an optical member having been formed on the substrate, after conducting at least one of the first releasing step and the second releasing step.

5. The method of claim 3, comprising the step of:
conducting a post-cure treatment for both optical members having been formed on both surfaces of the substrate after conducting the first releasing step and the second releasing step.

6. The method of claim 2, comprising the step of:
conducting the heat treatment at a temperature lower than the post-cure treatment temperature.

7. The method of claim 2, comprising the step of:
simultaneously conducting formation of an antireflective film and the post-cure treatment in an antireflective film formation step,
wherein the antireflective film is formed on the optical member after conducting the releasing step.

8. The method of claim 5, comprising the step of:
simultaneously conducting formation of an antireflective film and the post-cure treatment in an antireflective film formation step,
wherein the antireflective film is formed on the optical member after conducting the first releasing step or the second releasing step.

9. The method of claim 4, comprising the step of:
conducting the heat treatment at a temperature lower than the post-cure treatment temperature.

10. The method of claim 5, comprising the step of:
conducting the heat treatment at a temperature lower than the post-cure treatment temperature.
